(19) United States
(12) Patent Application Publication
(10) Pub. No.: US 2015/0355871 A1
(43) Pub. Date: Dec. 10, 2015

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: Hiroaki Nakata, Kawasaki-shi (JP)

(21) Appl. No.: 14/729,942

(22) Filed: Jun. 3, 2015

(30) Foreign Application Priority Data
Jun. 6, 2014 (JP) 2014-118113

(51) Int. Cl. G06F 3/12

(52) U.S. Cl. CPC G06F 3/1231; G06F 3/1285

(57) ABSTRACT

A method for controlling an image forming apparatus includes specifying an image forming apparatus, launching an application that responds to a search for image forming apparatuses, acquiring print function information relating to a print setting screen from the application, and displaying a print setting screen that corresponds to the specified image forming apparatus and is based on the print function information.

### BACKGROUND

1. Field

Aspects of the present invention generally relate to a print setting screen.

2. Description of the Related Art

Conventionally, techniques for restricting the function of a printer driver have been disclosed.

Japanese Patent Application Laid-Open No. 2010-271772 discusses a technique for installing a printer driver into an information processing apparatus and performing setting to restrict the print settings.

However, if the print settings need to be restricted in a plurality of information processing apparatuses, it is a troublesome job to perform setting in the individual information processing apparatuses by using the technique disclosed in Japanese Patent Application Laid-Open No. 2010-271772.

### SUMMARY

In some environments, it is impossible to change in advance the contents of a file for installing a printer driver into an information processing apparatus and then install the printer driver in which the use of a specific function is restricted. As a result, the function of the printer driver needs to be restricted via the image forming apparatus, for example.

Aspects of the present invention are generally directed to improving the convenience of a user by launching an application that responds, on an information processing apparatus, to a search for image forming apparatuses and then acquiring, from the launched application, print function information relating to a print setting screen. With this technique, a restriction can be put on a printer driver without performing setting in individual information processing apparatuses after the installation of the printer driver.

According to an aspect of the present invention, an information processing apparatus includes a specification unit configured to specify an image forming apparatus, a launching unit configured to launch an application that responds to a search for image forming apparatuses, an acquisition unit configured to acquire print function information relating to a print setting screen from the application, and a display unit configured to display a print setting screen that corresponds to the image forming apparatus specified by the specification unit and is based on the print function information.

Further features of the present disclosure will become apparent from the following description of exemplary embodiments with reference to the attached drawings.

### BRIEF DESCRIPTION OF THE DRAWINGS

FIG. 1 illustrates an example of a device configuration applicable to a printing system according to an exemplary embodiment.

FIG. 2 is a block diagram illustrating hardware configurations relating to the printing system according to the exemplary embodiment.

FIG. 3 is a block diagram illustrating software configurations relating to the printing system according to the exemplary embodiment.

FIG. 4 is a block diagram illustrating a component configuration of an installation set.

FIGS. 5A, 5B, and 5C each illustrate an example of generic printer description (GPD) files.

FIG. 6 is a flowchart illustrating customization processing of a printer driver by a customization application.

FIGS. 7A and 7B each are an example of a customization screen.

FIG. 8 illustrates a sequence of processing for installing a printer driver.

FIG. 9 illustrates an example of a user interface (UI) screen for installation.

FIG. 10 is an object diagram illustrating concepts of a driver, a queue, and a port.

FIG. 11 is a block diagram illustrating a subcomponent configuration of a virtual Web Services on Devices (WSD) application.

FIG. 12 is a flowchart illustrating a flow of integrated extension processing.

FIGS. 13A and 13B illustrate examples of a MetaData acquisition message and a MetaData acquisition response message, respectively.

FIGS. 14A and 14B illustrate examples of a PrinterElement acquisition message and a PrinterElement acquisition response message, respectively.

FIGS. 15A and 15B are flowcharts illustrating customized queue registration processing.

FIGS. 16A and 16B each are an object diagram illustrating a state during the customized queue registration processing.

FIGS. 17A and 17B each illustrate an example of a customized print setting screen.

FIGS. 18A and 18B each illustrate an example of a paper type registration screen.

FIG. 19 illustrates an example of a paper type database.

FIG. 20 is a flowchart illustrating a flow of printer extension GPD file generation processing.

FIGS. 21A, 21B, and 21C each illustrate an example of a GPD file.

### DESCRIPTION OF THE EMBODIMENTS

Hereinafter, a first exemplary embodiment will be described with reference to the attached drawings.

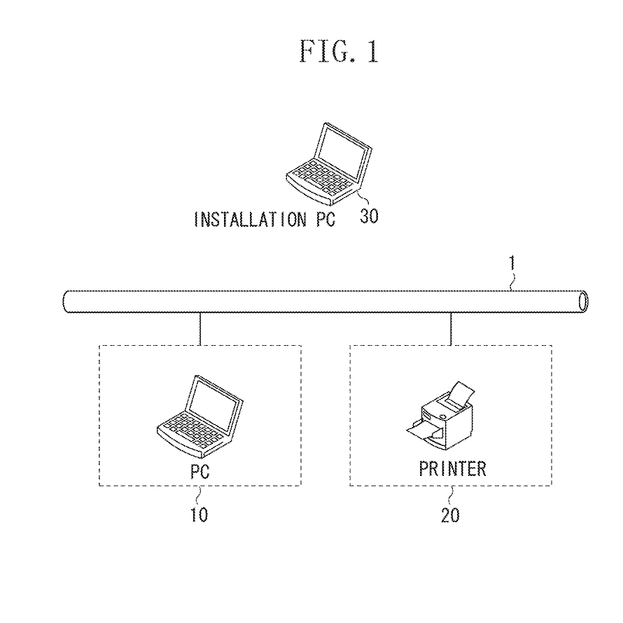

FIG. 1 illustrates an example of a device configuration of a printing system according to the first exemplary embodiment. The printing system includes a personal computer (PC) 10, which is an example of an information processing apparatus, a printer 20, which is an example of an image forming apparatus, and a PC 30 for installation (hereinafter referred to as an installation PC).

In an environment (hereinafter, referred to as a print environment) in which a customer performs a printing operation, the PC 10 and the printer 20 are installed, and the PC 10 and the printer 20 are interconnected via a local area network (LAN) 1.

The PC 10 is used by the user (customer). The LAN 1 supports communication methods complying with Ethernet (registered trademark). For the LAN 1, besides wired LANs and wireless LANs, connection methods other than LANs such as Bluetooth (registered trademark) and a universal serial bus (USB) can be used. In this printing system, a single PC 10 and a single printer 20 are installed. However, a plurality of PCs 10 and a plurality of printers 20 can be used.

An environment (customization environment) for customizing a printer driver is provided at a location different from the print environment, and the installation PC 30 is installed in the customization environment. The installation PC 30 is used by a system engineer who introduces the print environment. The system engineer customizes a printer driver by using a customization application on the installation PC 30. An installation set for installing the customized printer driver is introduced into the print environment by using a transportable medium, or the like. The installation PC 30 may be connected to the LAN 1 on the printing system. When the installation PC 30 is connected to the LAN 1, the installation set can be introduced into the print environment via the LAN 1. In the above description, the device configuration of the printing system and an overview of the system have been described.

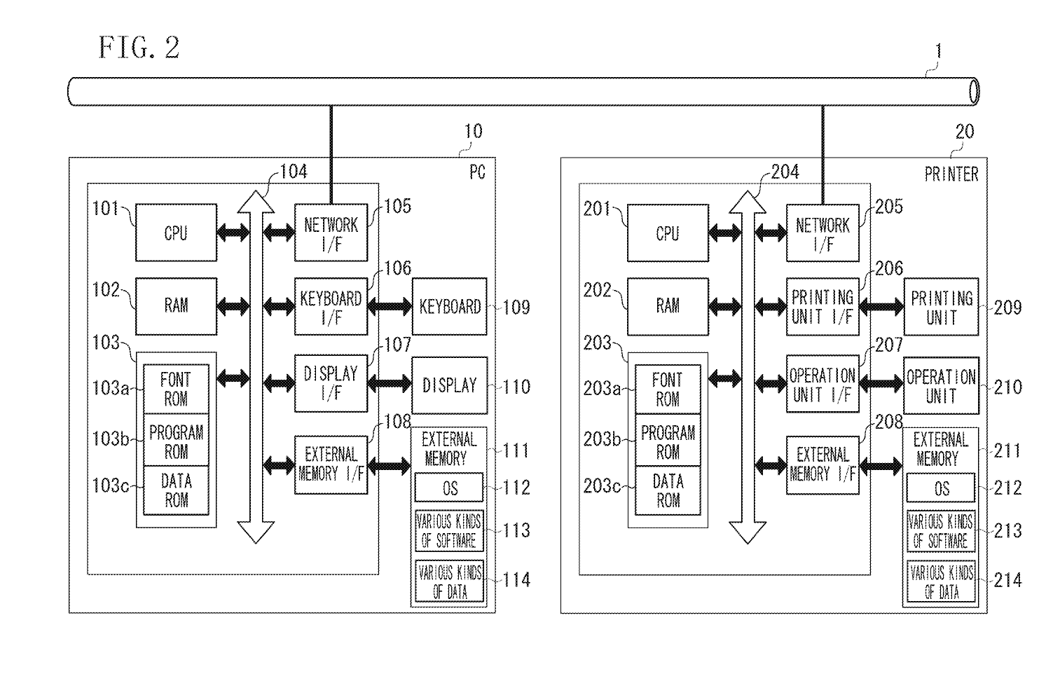

FIG. 2 is a block diagram illustrating hardware configurations applicable to the respective apparatuses.

A hardware configuration of the PC 10 will be described first.

A central processing unit (CPU) 101 performs overall control of devices connected to a system bus 104, according to a program stored in a random access memory (RAM) 102.

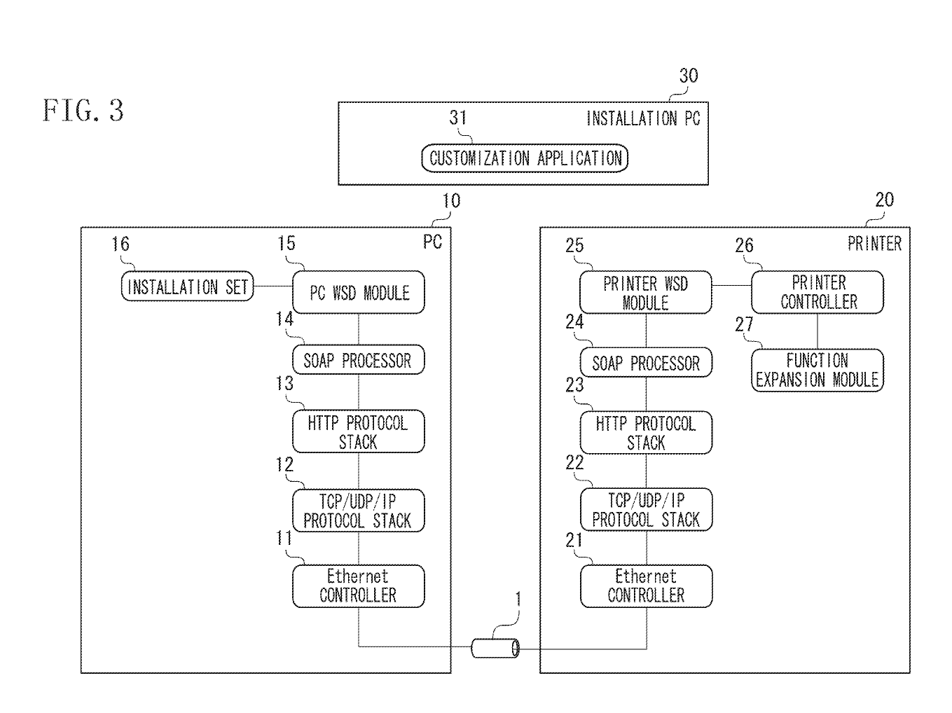

The CPU 101 also executes processing according to a program stored in an external memory 111 to implement a software configuration of the PC 10 illustrated in FIG. 3, and processing in each step of flowcharts to be described below.

The RAM 102 serves as a main memory, a work area, or the like of the CPU 101.

A read-only memory (ROM) 103 stores various programs and various kinds of data. The ROM 103 is divided into a font ROM 103a for storing various fonts, a program ROM 103b for storing a boot program, a basic input/output system (BIOS), and the like, and a data ROM 103c for storing various kinds of data.

A network interface (I/F) 105 is connected to the LAN 1 to perform communication processing. A keyboard controller I/F 106 controls input from a keyboard 109 or a pointing device (not illustrated) such as a mouse. A display I/F 107 controls display processing on a display 110.

An external memory I/F 108 controls, for example, access to the external memory 111 such as a hard disk. The external memory 111 functions as a storage medium for storing an operating system (OS) 112, various kinds of software 113 implementing the printing system according to an exemplary embodiment, and various kinds of data 114 such as user files and edited files. The OS 112 is not limited to a specific type. In the present exemplary embodiment, a Microsoft (registered trademark) Windows (registered trademark) operating system is used.

Next, a hardware configuration of the printer 20 will be described.

A CPU 201 performs overall control of devices connected to a system bus 204, according to a program stored in a RAM 202.

The CPU 201 also executes processing according to a program stored in an external memory 211 to implement a software configuration of the printer 20 illustrated in FIG. 3, and the processing in each step of the flowcharts to be described below.

The RAM 202 functions as a main memory, a work area, or the like of the CPU 201, and is also used as an output information rasterization area or an environment data storage area. The RAM 202 includes a nonvolatile RAM (NVRAM) area, and the memory capacity can be expanded by an optional RAM to be connected to an expansion port (not illustrated).

A ROM 203 includes a font ROM 203a for storing various fonts, a program ROM 203b for storing a control program to be executed by the CPU 201, and the like, and a data ROM 203c for storing various kinds of data.

A network interface (I/F) 205 is connected to the LAN 1 to perform communication processing. A printing unit I/F 206 controls an interface to a printing unit 209, which serves as a printer engine. An operation unit 210 is controlled by an operation unit I/F 207 and includes an operation panel for receiving an operation from a user. The operation panel includes switches for allowing the user to perform operations, a light-emitting diode (LED) display device, and the like.

An external memory I/F 208 controls, for example, access to the external memory 211 such as a hard disk. The external memory 211 functions as a storage medium for storing an operating system 212 for devices, various kinds of software 213, and various kinds of data 214.

The CPU 201 is capable of performing communication processing with the PC 10 via the network I/F 205, and receives page description language (PDL) data transmitted from the PC 10. The PDL is not limited to a specific type. In an exemplary embodiment, an XML Paper Specification (XPS) format is used. The CPU 201 can output an image signal obtained by converting the PDL to the printing unit 209 via the printing unit I/F 206, according to a control program stored in the program ROM 203b.

The installation PC 30 has a hardware configuration similar to that of the PC 10 and uses an OS similar to that in the PC 10, and the detailed description thereof is thus omitted.

FIG. 3 illustrates a configuration of software for performing processing relating to the printing system in the PC 10, printer 20, and the installation PC 30.

First, a software configuration of the PC 10 will be described.

Software components 11 to 16 in the PC 10 are stored in the external memory 111, and they are loaded into the RAM 102 at the time of execution and executed by the CPU 101.

An Ethernet (registered trademark) controller 11 controls Ethernet (registered trademark) communication processing via the network I/F 105.

A Transmission Control Protocol/User Datagram Protocol/Internet Protocol (TCP/UDP/IP) protocol stack 12 located in the upper layer of the Ethernet controller 11 controls TCP/UDP/IP protocol communication.

A Hypertext Transfer Protocol (HTTP) protocol stack 13 located in the upper layer of the TCP/UDP/IP protocol stack 12 controls HTTP communication processing, and a Simple Object Access Protocol (SOAP) processor 14 located in the upper layer of the HTTP protocol stack 13 controls SOAP communication processing. The SOAP is a communication protocol used in the Web service technology for calling processing or data of a device from the device.

A PC WSD module 15 controls Web Services on Devices (WSD) communication processing via the SOAP processor 14. WSD is a Web service technology of which specifications are developed by Microsoft Corporation.

An installation set 16 is software including components such as a printer driver and an installer for installing the printer driver. The installation set 16 will be described in detail below.

Next, a software configuration of the printer 20 will be described.

Software components 21 to 27 in the printer 20 are stored in the external memory 211, and they are loaded into the RAM 202 at the time of start of processing and executed by the CPU 201.

An Ethernet (registered trademark) controller 21 controls Ethernet (registered trademark) communication processing via the network I/F 205.

A TCP/UDP/IP protocol stack 22 located in the upper layer of the Ethernet controller 21 controls TCP/UDP/IP protocol communication.

An HTTP protocol stack 23 located in the upper layer of the TCP/UDP/IP protocol stack 22 controls HTTP communication processing, and a SOAP processor 24 located in the upper layer of the HTTP protocol stack 23 controls SOAP communication processing.

A printer WSD module 25 controls WSD communication processing via the SOAP processor 24. The printer WSD module 25 is controlled by a printer controller 26.

The printer controller 26 also performs processing relating to device settings that are input from the operation unit 210.

A function expansion module 27 performs processing for updating functional information according to the device settings.

Lastly, a software configuration of the installation PC 30 will be described.

A customization application 31 on the installation PC 30 is stored in an external memory, and it is loaded into a RAM at the time of execution and executed by a CPU.

The customization application 31 is an application program for customizing a printer driver.

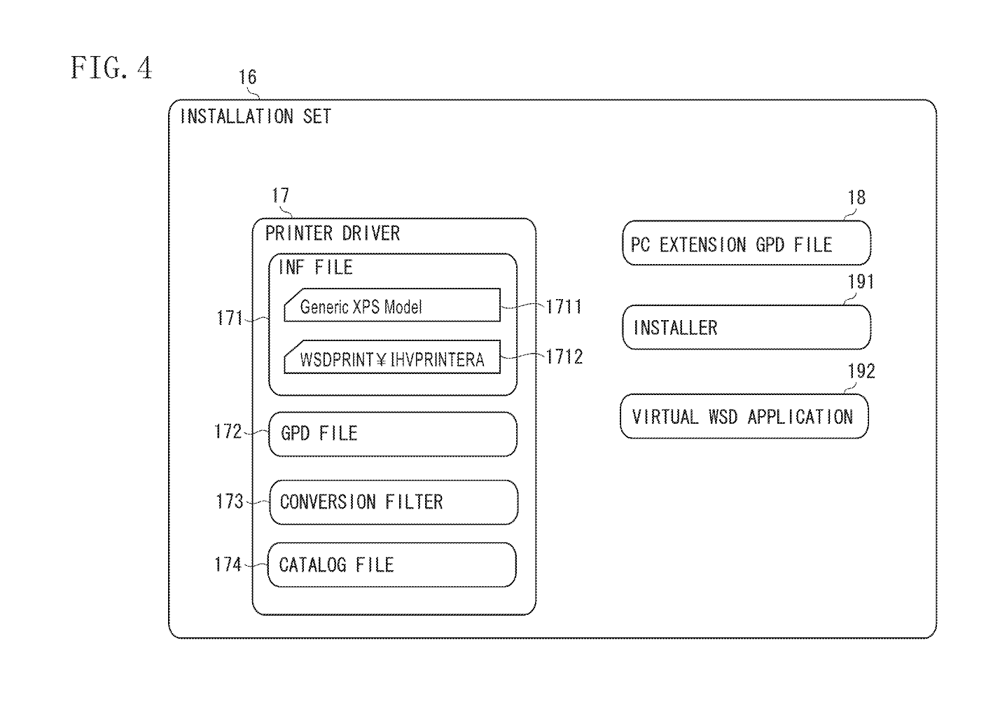

With reference to FIG. 4, components of the installation set 16 will be described in detail.

The components to be described below exist as file data, and the installation set 16 is stored in the external memory 111 as folder data for managing the file data.

A printer driver 17 is software for performing printing on the printer 20. The printer driver 17 includes an INF file 171, a generic printer description (GPD) file 172, a conversion filter 173, and a catalog file 174. Hereinafter, each of the components will be described in detail.

The INF file 171 is a text data file including information of a model name 1711 and a hardware ID 1712. The model name 1711 is information of a model name that is paired with the hardware ID 1712.

The hardware ID is identifier information for associating a device and a device driver with each other.

The printer driver 17 and the printer 20 are associated with each other by matching a hardware ID generated from a device ID contained in information that can be acquired from the printer 20, and the hardware ID 1712 described in the INF file 171. In the present exemplary embodiment, it is assumed that the hardware ID acquired from the printer 20 is the character string value “WSDPRINT\IHVPRINTERA”, and matches the hardware ID 1712 of the INF file.

The GPD file 172 is a text data file in which print function information of the printer driver 17 is defined. The print function information is information relating to a print setting screen of the printer driver 17. The OS 112 generates a print setting screen based on the print function information defined in the GPD file 172, and displays the print setting screen.

The conversion filter 173 is an execution module file for performing layout processing.

The catalog file 174 is a data file for detecting tampering. The OS 112 has a function of comparing the files constituting the printer driver 17 with the catalog file 174 to detect tampering in the files, and rejecting installation of the printer driver 17 that has been tampered.

Thus, in an exemplary embodiment, the GPD file 172, which is a component of the printer driver 17, cannot be directly changed to customize the printer driver 17. Consequently, the customization of the printer driver 17 is implemented by recording the contents of customization into a PC extension GPD file 18, which is not a component of the printer driver 17 in the installation set 16, and combining the GPD file 172 and the PC extension GPD file 18 by using the OS 112.

More specifically, the PC extension GPD file 18 is a data file in the installation set 16, which is to be generated separately from the GPD file 172 after the printer driver 17 is customized. A method of generating the PC extension GPD file 18 will be described below.

An installer 191 is an execution module file for installing and customizing the printer driver 17.

A virtual WSD application 192 is an execution module file to be executed by the installer 191, and provide assistance in the installation processing of the printer driver 17. The virtual WSD application 192 is a program module to be executed on the PC 10, but is also capable of performing WSD communication processing to behave as if it were a printer located on the LAN 1. This enables the virtual WSD application 192 to respond, on the PC 10 (information processing apparatus), to a search for printers (image forming apparatuses) on a network.

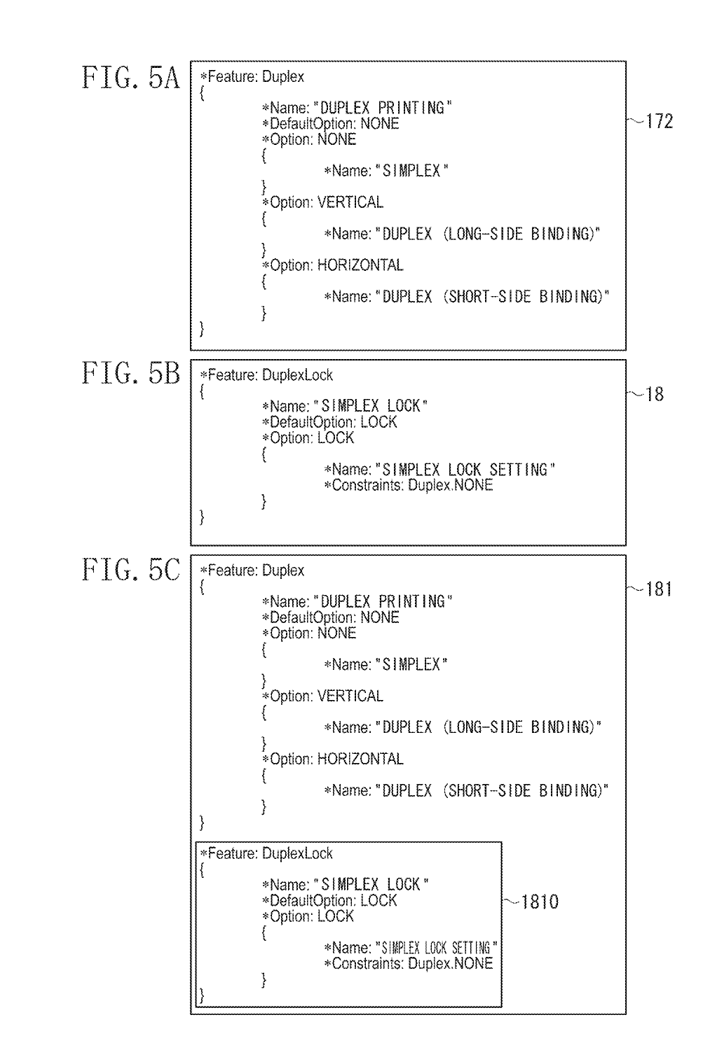

FIG. 5A illustrates an example of the GPD file 172. In the GPD file 172, various kinds of setting information that can be input via the printer driver 17 is defined. The setting information includes, for example, the number of sheets to be printed, a sheet orientation, a sheet size, a sheet type, single/duplex, and a sheet feeding method.

Among these pieces of setting information, an example of setting information of duplex setting (“Feature: Duplex”) is extracted and illustrated in FIG. 5A. More specifically, as the selectable items of the duplex setting, information about three items, “SIMPLEX”, “DUPLEX (LONG-SIDE BINDING), and “DUPLEX (SHORT-SIDE BINDING)” is described.

In FIG. 5A, the Option attribute values “NONE”, “VERTICAL”, and “HORIZONTAL” correspond to an ID for duplex printing specification to be reflected in the PDL generated by the printer driver 17. The Name attribute values “SIMPLEX”, “DUPLEX (LONG-SIDE BINDING), and “DUPLEX (SHORT-SIDE BINDING)” correspond to letters to be directly displayed on a print setting screen provided by the printer driver 17.

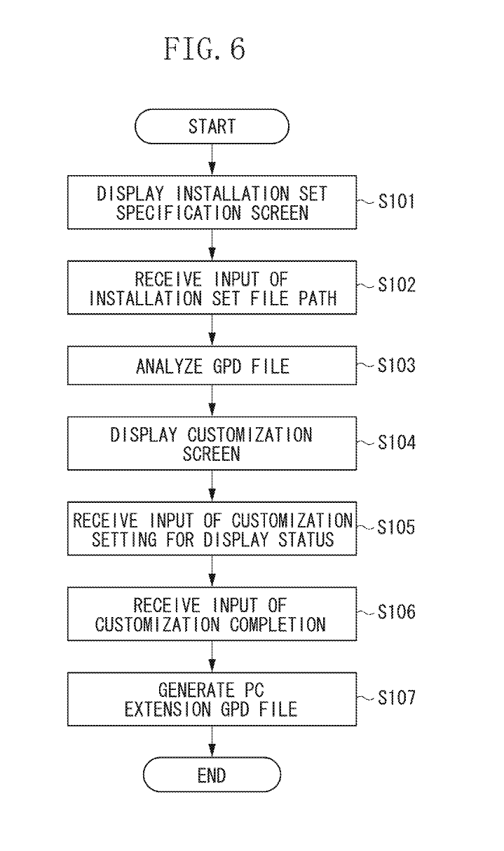

FIG. 6 is a flowchart illustrating customization processing of the printer driver 17 by the customization application 31 according to the first exemplary embodiment.

On a print setting screen of the printer driver 17, the options “SIMPLEX”, “DUPLEX (LONG-SIDE BINDING), and “DUPLEX (SHORT-SIDE BINDING)” are provided for a print function of duplex setting, for example.

In the present exemplary embodiment, to meet the customer's need to save the number of print sheets, customization is performed in such a way that the option “SIMPLEX” is disabled, and only one of the options “DUPLEX (LONG-SIDE BINDING) and “DUPLEX (SHORT-SIDE BINDING)” can be selected.

As described above, the customization application 31 is an application to be executed on the installation PC 30 in the customization environment, and a system engineer inputs customization information according to a customization specification based on the customer's need. The customization information is stored as the PC extension GPD file 18 in the installation set 16.

Hereinafter, a customization procedure performed by the customization application 31 will be described with reference to the flowchart in FIG. 6.

In step S101, when the customization application 31 is launched, the customization application 31 displays an installation set specification screen.

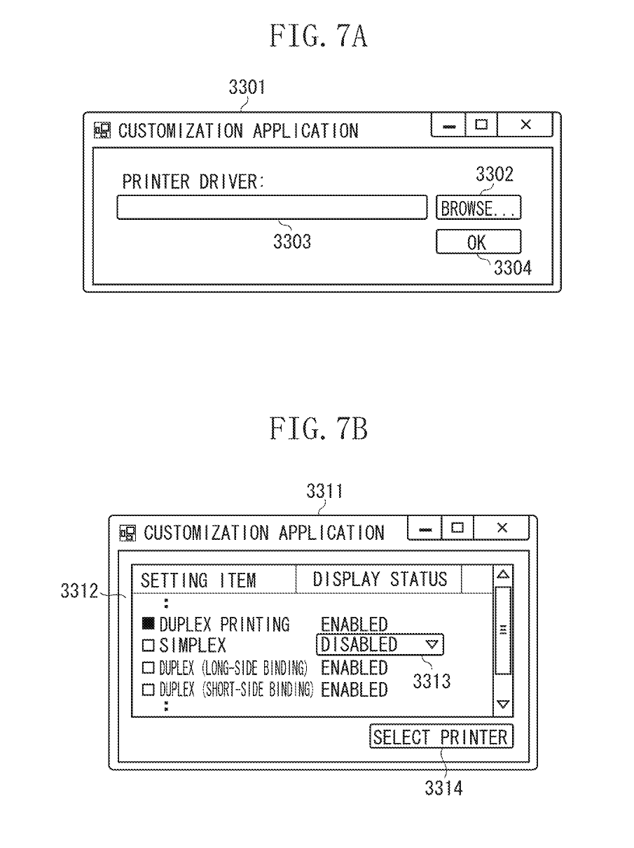

FIG. 7A illustrates an example of an installation set specification screen 3301 of the customization application 31.

In step S102, when a BROWSE button 3302 is pressed, the customization application 31 displays a dialog for specifying a file path, and receives an input of the file path in which the printer driver 17 to be customized is stored.

In step S103, the input file path is displayed on a text box 3303, and the GPD file 172 in the printer driver 17 is analyzed in response to an OK button 3304 being pressed. In step S103, the lexical structure of the GPD file 172 illustrated in FIG. 5A is analyzed, and information such as a function, items, and the respective display names is extracted.

When the analysis is completed, then in step S104, a customization screen is displayed.

FIG. 7B illustrates an example of a customization screen 3311 of the customization application 31.

A print function and its item names are listed, and displayed on a list 3312 illustrated in FIG. 7B. As illustrated in the example in FIG. 7B, as a print function and its items, display names “▪DUPLEX PRINTING”, “□SIMPLEX”, “□DUPLEX (LONG-SIDE BINDING)”, and “□DUPLEX (SHORT-SIDE BINDING)” are displayed in the “SETTING ITEM” column. In the next “DISPLAY STATUS” column, display statuses of the respective items are displayed.

The display statuses of the items include two types of statuses, “ENABLED” and “DISABLED”. In step S105, a combo box 3313 displayed by clicking the “DISPLAY STATUS” column allows reception of a customization setting relating to the display status of an item. When the display status of an item (“SIMPLEX” in the present exemplary embodiment) is changed from “ENABLED” to “DISABLED”, customization is performed to disable the selection of the item on the printer driver 17 that is finally operated by the user.

In step S106, in response to a SELECT PRINTER button 3314 being pressed, the customization application 31 receives an input of completion of the customization. In step S107, the customization application 31 generates the PC extension GPD file 18. An example of the PC extension GPD file 18 and its role in the printing system will be described below.

The customization processing by the customization application 31 has been described in the above description.

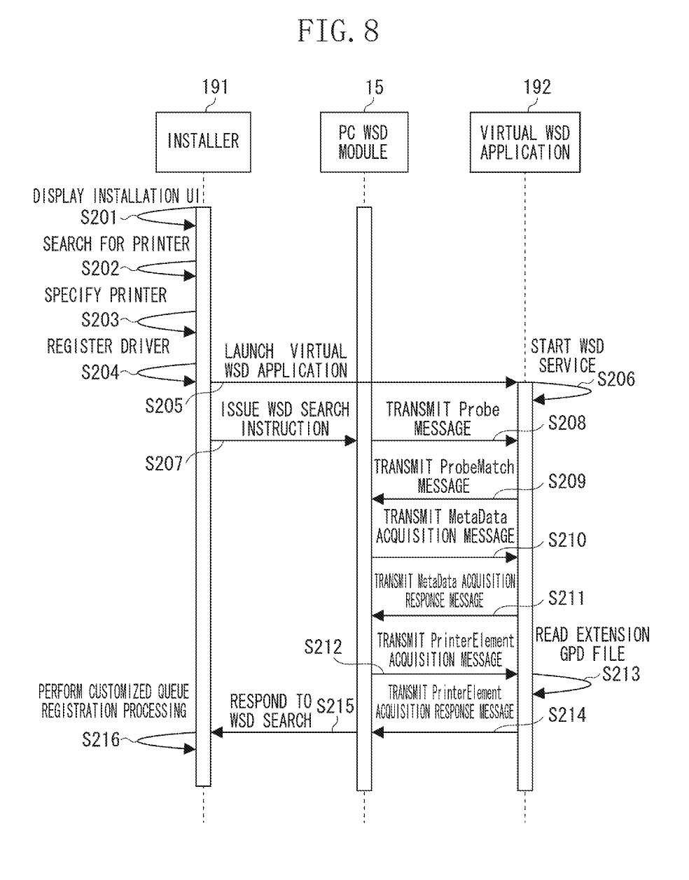

With reference to the sequence diagram in FIG. 8, installation processing of the printer driver 17 according to the first exemplary embodiment will be described.

The installation processing is performed by the installer 191, the PC WSD module 15, and the virtual WSD application 192 located on the PC 10 in the print environment.

Among these, the installer 191 and the virtual WSD application 192 are programs included in the customized installation set 16 that has been brought from the customization environment to the print environment via a transportable medium, or the like by a system engineer.

The installer 191 and the virtual WSD application 192 perform processing for introducing the printer driver 17 and the PC extension GPD file 18, which are also included in the customized installation set 16, into the OS 112.

The installer 191 performs processing to start the installation processing. The operation of an installation user interface (UI) of the installer 191 is performed by the user (i.e. the customer) by himself/herself.

In step S201, when the user starts the installer 191, the installer 191 displays the installation UI.

In step S202, the installer 191 performs printer search processing and displays a result of the search.

The printer search processing refers to processing in which a network protocol is used to search for printers connected to the LAN 1. It is assumed that TCP/IP broadcast or multicast is used to search for peripheral devices such as printers connected to the LAN 1. The search result includes information of the peripheral devices on the LAN 1 found as a result of the search. It is also assumed that a Simple Network Management Protocol (SNMP) is used to acquire information such as a name and type (for example, whether the device is a printer) of the found peripheral device.

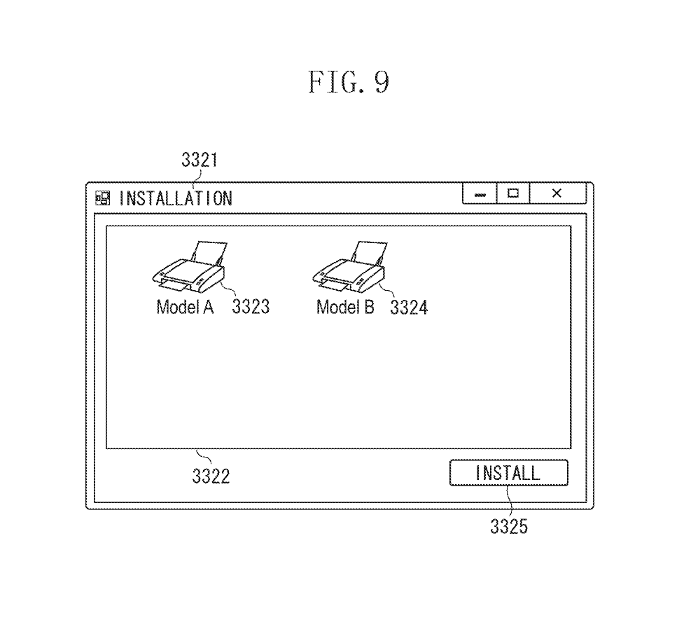

FIG. 9 illustrates a screen 3321 of the installation UI.

As a result of the printer search processing, if the number of printers 20 connected to the printing system is one, information of the printer 20 is displayed as the search result on a list box 3322 with an icon and characters, and if a plurality of printers 20 is connected to the printing system, information of the plurality of printers 20 is displayed on the list box 3322 with icons and characters. The user can select one of icons 3323 and 3324 displayed on the list box 3322 with a cursor, and the printer 20 corresponding to the selected icon is input in the installer 191 as a print output destination.

In step S203, when an INSTALL button 3325 is pressed, the installer 191 specifies the printer 20 that is a print output destination. Then, the installer 191 stores IP address information of the specified printer 20.

That is, the installer 191 searches for image forming apparatuses on the network and enables the user to select a desired image forming apparatus from the image forming apparatuses found as a result of the search, so that the installer 191 specifies the image forming apparatus.

The printer 20 can be specified by enabling the user to select a desired printer from the printers found by search as in steps S202 and S203, or alternatively by enabling the user to directly input the IP address of a desired printer.

In step S204, the installer 191 registers the printer driver 17 corresponding to the input printer 20.

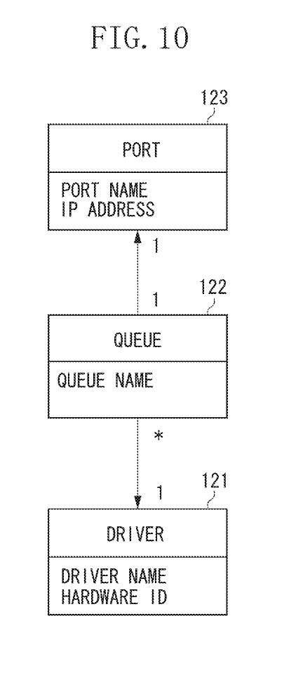

With reference to FIG. 10, concepts of a driver 121, a queue 122, and a port 123 in the OS 112 will be described.

FIG. 10 is an object diagram in a Unified Modeling Language (UML).

In a print management system of the OS 112, the external memory 111 manages information about installation information of a printer driver, a printer serving as an output destination, and a type of connection with the printer. Those pieces of information is abstracted as objects. Through an application program interface (API) provided by the OS 112, the information can be generated, read, or changed by document generation software for performing printing, or set up software such as the installer 191.

The driver 121 is an object corresponding to the printer driver 17. The driver 121 is generated when the printer driver 17 is registered by the API, and copied in an area on the external memory 111 managed by the OS 112. The queue 122, which will be described below, cannot be registered without the corresponding driver 121, and thus the processing to register the driver 121 is required to register the queue 122. The driver 121 includes, as its properties, a driver name and a hardware ID.

The queue 122 is an object corresponding to a print output destination, and includes a queue name as its property.

The port 123 is an object corresponding to the type of connection with the output destination, and includes a port name and an IP address as its properties.

The queue 122 and the port 123 are generated via the API, and the port 123 needs to be generated first.

The queue 122 is associated with the port 123 and the driver 121, and the multiplicity is illustrated in FIG. 10. More specifically, the queue 122 and the driver 121 are associated with each other, and the driver 121 is associated with zero or more queues 122. The queue 122 and the port 123 are associated with each other, and the port 123 and the queue 122 are associated in a one-to-one correspondence.

Referring to FIG. 8 again, the description will be continued. After the registration of the printer driver 17 in step S204, in step S205, the installer 191 launches the virtual WSD application 192.

After the virtual WSD application 192 is launched, then in step S206, the virtual WSD application 192 starts a WSD service. The WSD service refers to processing on the server side in the WSD communication processing. The WSD service can also be provided by a peripheral device such as a printer. In the printing system according to an exemplary embodiment, to apply customization information to the print environment, the virtual WSD application 192, which is a program on the PC 10, behaves as if it were a peripheral device.

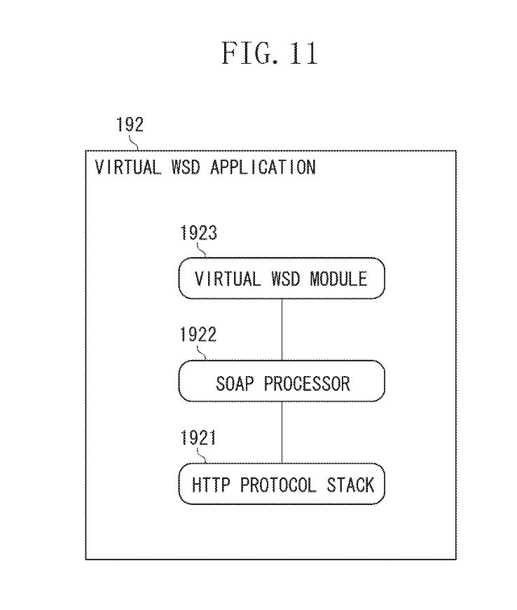

With reference to FIG. 11, subcomponents of the virtual WSD application 192 will be described.

An HTTP protocol stack 1921 controls HTTP communication processing, and a SOAP processor 1922 controls SOAP communication processing. A virtual WSD module 1923 controls WSD communication processing via the SOAP processor 1922.

Referring to FIG. 8 again, the description will be continued. In step S207, the installer 191 issues a WSD search instruction to the PC WSD module 15 via the API. The issue of the WSD search instruction is the processing to instruct the PC WSD module 15 to search for printers on the network using WSD communication. A response to the issued WSD search instruction (S207) is obtained as a WSD search response (S215) to be described below, and thus the processing from step S208 to S214 can be referred to as WSD search processing.

In response to receiving the search instruction from the installer 191, in step S208, the PC WSD module 15 generates a Probe message and transmits it to the virtual WSD application 192. The Probe message is transmitted to search for WSD-compliant devices.

The WSD communication processing between the PC WSD module 15 and the virtual WSD application 192 side is performed by the SOAP processor 14, the HTTP protocol stack 13, the TCP/UDP/IP protocol stack 12, the Ethernet (registered trademark) controller 11, the HTTP protocol stack 1921, the SOAP processor 1922, and the virtual WSD module 1923. Hereinafter, the processing is briefly described as communication processing between the PC WSD module 15 and the virtual WSD module 1923.

In response to receiving the Probe message, in step S209, the virtual WSD module 1923 generates a ProbeMatch message, and responds to the PC WSD module 15. The ProbeMatch message is a message for responding to Probe. The ProbeMatch message for response includes information such as a device type and a uniform resource locator (URL) for MetaData acquisition. The MetaData is a collection of information such as a printer name, and a URL of a printer service.

In step S210, the PC WSD module 15 generates a MetaData acquisition message 2401 from the URL information for MetaData acquisition obtained from the ProbeMatch message, and transmits the message to the virtual WSD module 1923.

In response to receiving the MetaData acquisition message 2401, in step S211, the virtual WSD module 1923 generates a MetaData acquisition response message 2402 and responds to the PC WSD module 15.

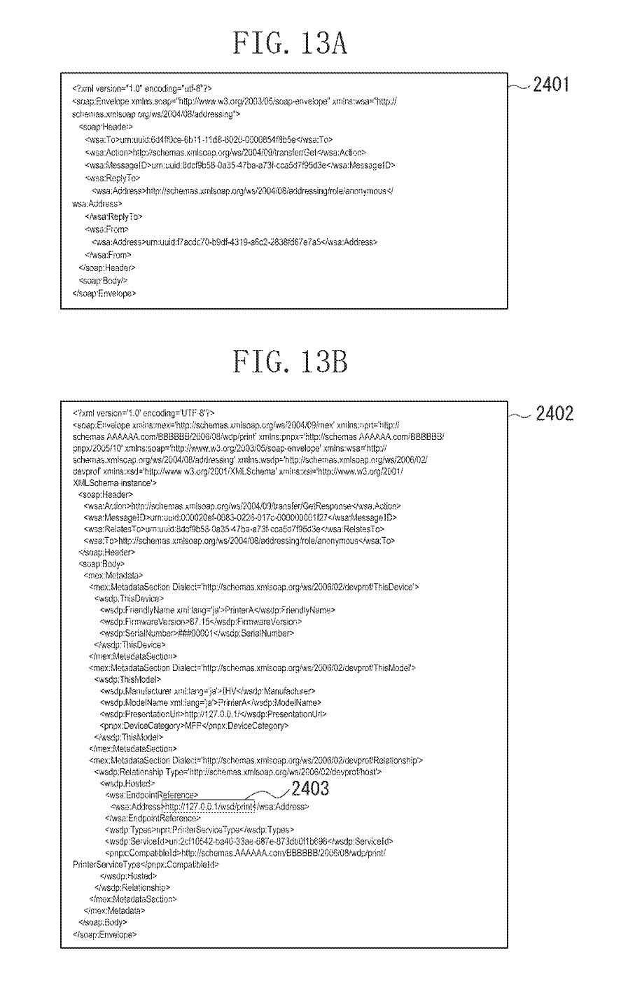

FIG. 13A illustrates an example of the MetaData acquisition message 2401 and FIG. 13 B illustrates an example of the MetaData acquisition response message 2402. The MetaData acquisition response message 2402 includes, for example, a printer name and an address 2403 of a printer service.

In step S212, the PC WSD module 15 generates a PrinterElement acquisition message 2501, and transmits the message to the virtual WSD module 1923.

In response to receiving the PrinterElement acquisition message 2501, in step S213, the virtual WSD module 1923 reads the PC extension GDP file 18 included in the installation set 16.

In step S214, the virtual WSD module 1923 generates a PrinterElement acquisition response message 2502 and responds to the PC WSD module 15.

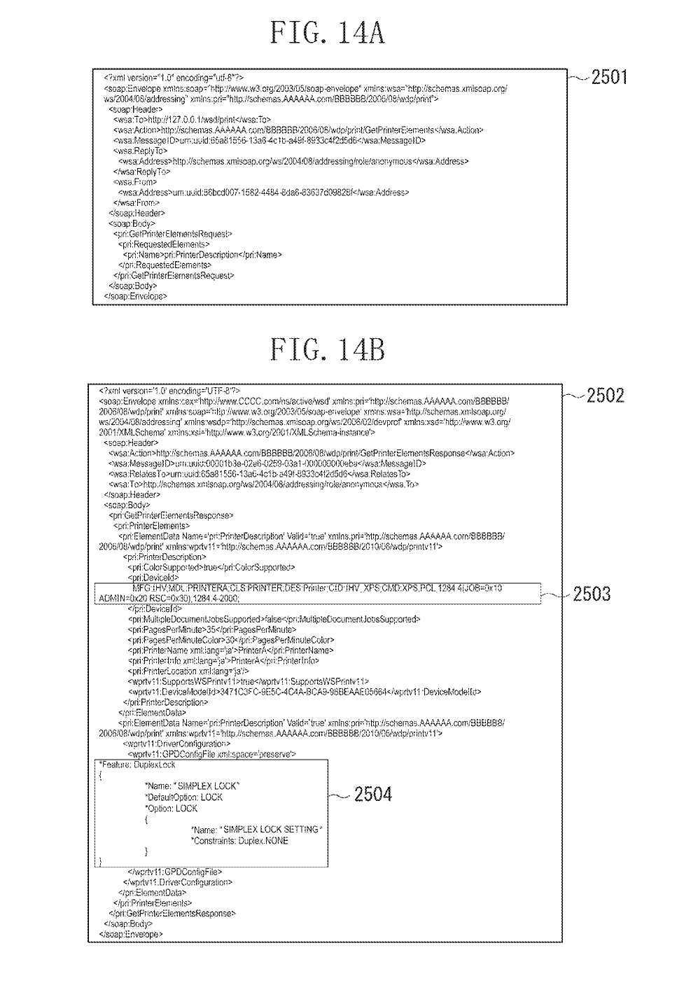

FIG. 14A illustrates an example of the PrinterElement acquisition message 2501, and FIG. 14B illustrates an example of the PrinterElement acquisition response message 2502. The PrinterElement acquisition response message 2502 includes a device ID (DeviceID) 2503, and a print function information 2504 of the PC extension GPD file 18 read in step S213. The PrinterElement acquisition response message 2502 further includes information such as a color printing capability and a print speed.

In step S215, the PC WSD module 15 transmits to the installer 191 the information obtained from the MetaData acquisition response message 2402 and the PrinterElement acquisition response message 2502, as information of the response to the WSD search. The installer 191 can obtain print function information from the virtual WSD application 192 since the response to the WSD search includes the print function information 2504 of the PC extension GPD file 18.

The WSD search instruction is issued to arbitrary WSD services operating on the devices connected to the LAN 1, and not only the virtual WSD application 192 on the PC 20, but also the printer 20 may respond to the instruction.

Thus, the search result is a list of the information (WSD service information) obtained from the WSD services. In the processing in step S216 to be described below, only a target WSD service needs to be extracted from the search result.

The processing in step S216 is customized queue registration processing for registering a queue having a customized print function (hereinafter, referred to as a customized queue).

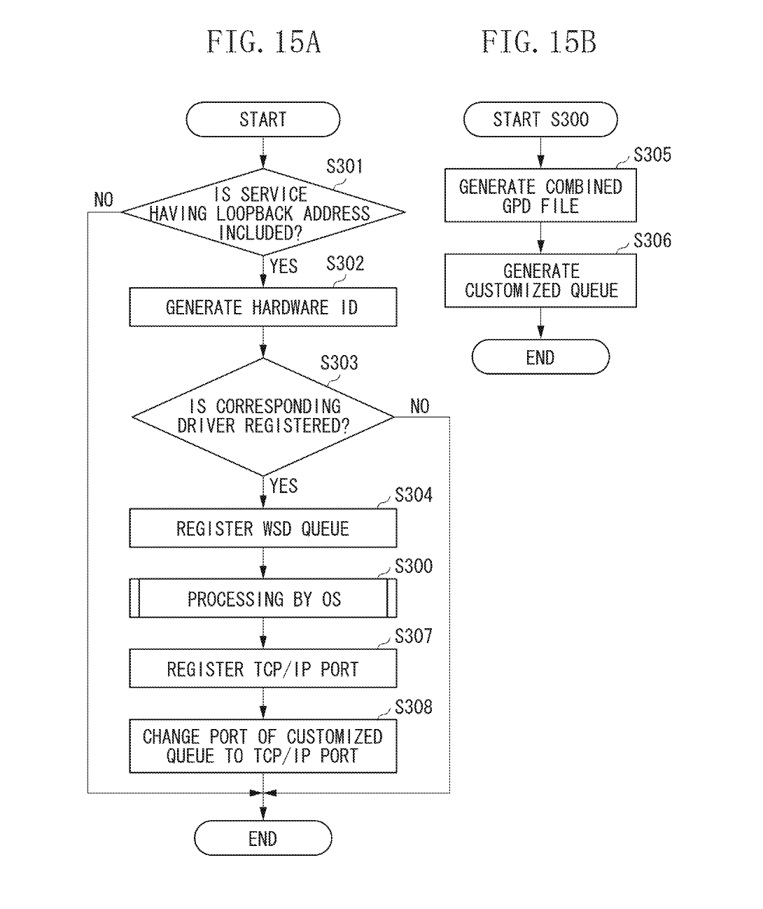

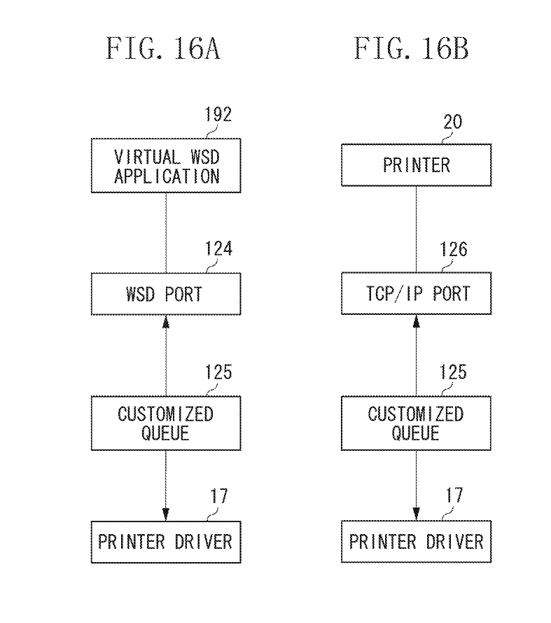

With reference to the flowcharts in FIGS. 15A and 15B, and the object diagrams in FIGS. 16A and 16B, the customized queue registration processing will be described.

In step S301, the installer 191 searches, from the list of the WSD service information included in the WSD search response, for a printer service having a loopback address as the address 2403 among the printer services included in the MetaData acquisition response message 2402.

The loopback address is an IP address indicating a node of a printer service, and the value “127.0.0.1” is used. If the address 2403 of a printer service is the loopback address, the WSD service that sent the response is the virtual WSD application 192 operating on the PC 10.

If there is a WSD service having the loopback address, the installer 191 proceeds to step S302, and if there is no WSD service having the loopback address, the processing ends as an error.

In step S302, the installer 191 generates a hardware ID from the device ID 2503 included in the PrinterElement acquisition response message 2502. The device ID 2503 is the source information of the hardware ID. The installer 191 combines the value “MFG: IHV” and the value “MDL: PRINTERA” included in the device ID 2503 to obtain the value “IHVPRINTERA” of the hardware ID.

In step S303, the installer 191 determines whether a driver having a hardware ID property that matches the hardware ID obtained in step S302 is registered. If there is a hardware ID property that matches the hardware ID (YES in step S303), the processing proceeds to step S304, and if not, the processing ends as an error.

In step S304, the installer 191 calls the API to register a queue that specifies the virtual WSD application 192 as the output destination and WSD as the connection type.

With reference to FIG. 15B, the processing of the OS (S300) performed by calling the API will be described.

The OS 112 registers a WSD port 124 that specifies the virtual WSD application 192 as the output destination.

In step S305, the OS 112 combines the PC extension GPD file 18 included in the PrinterElement acquisition response message 2502 and the GPD file 172 to generate a combined GPD file 181.

In step S306, the OS 112 generates a customized queue (customized queue 125) that specifies the combined GPD file 181 associated with the WSD port 124 as the print function.

Referring to FIG. 15A again, the processing of the installer 191 will be described.

In step S307, the installer 191 registers, via the API, the TCP/IP port 126 that specifies the printer 20 as the output destination and TCP/IP as the connection type, based on the IP address information stored in step S203.

In step S308, the installer 191 changes the port of the customized queue 125 from the WSD port 124 to the TCP/IP port 126 via the API.

By this processing, the output destination of the customized queue 125 is changed from the virtual WSD application 192 to the printer 20 specified by the user using the screen illustrated in FIG. 9. Thus, by specifying and outputting the customized queue 125, the user can perform printing on the printer 20. Furthermore, this processing allows displaying, as a print setting screen for the printer driver 17 corresponding to the customized queue 125, a screen that corresponds to the printer 20 specified by the user using the screen illustrated in FIG. 9 and that is based on the print function information 2504 acquired from the virtual WSD application 192.

FIG. 5B illustrates an example of the PC extension GPD file 18.

The PC extension GPD file 18 is combined with the original GPD file 172 in the installation processing of the printer driver 17 to be information for specifying the print function of the customized queue 125 as the combined GPD file 181.

FIG. 5C illustrates an example of the combined GPD file 181.

In the latter part of the combined GPD file 181 according to the present exemplary embodiment, that is, in a part 1810 that is added by the PC extension GPD file 18, a customized specification for disabling the selection of the duplex printing function item “SIMPLEX” is described.

More specifically, the function “DuplexLock” having the item “LOCK” is specified, and the “*Constraints” description, which specifies the disabling of selection of the item SIMPLEX (“Duplex. NONE”) in the duplex printing simultaneously with the item “LOCK”, is included. The item “LOCK” is the only function specified in the DuplexLock function, and the item is always in the selected state. More specifically, since the item “LOCK” that is always in the selected state and the item SIMPLEX (“Duplex. NONE”) cannot simultaneously be selected, the item “SIMPLEX” is put in the disabled state and cannot be selected on the print setting screen of the printer driver 17. A function that has only one option is not displayed on the print setting screen. Consequently, since the function “DuplexLock” has only one option “LOCK”, the function is not displayed on the print setting screen.

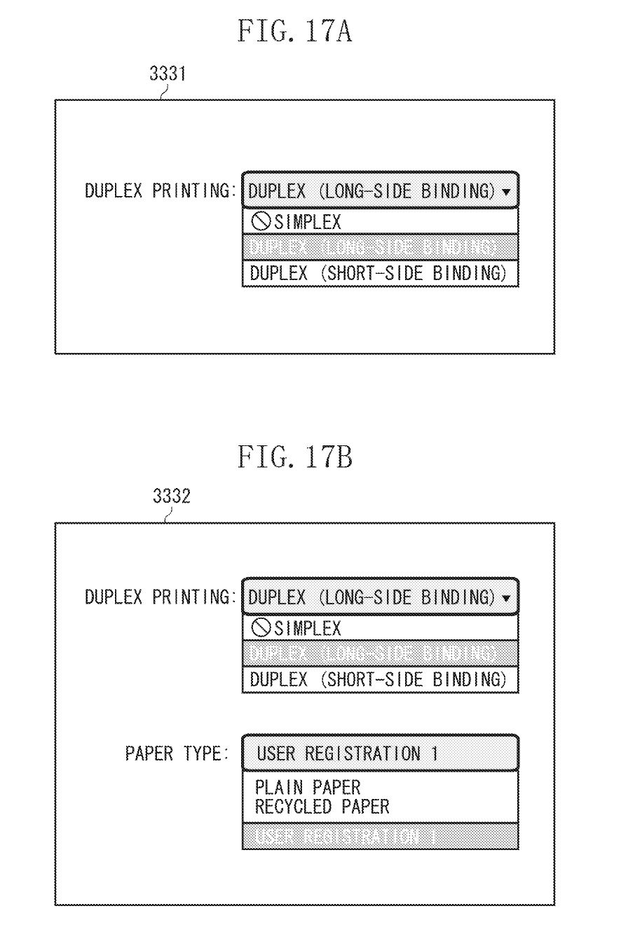

FIG. 17A illustrates a customized print setting screen 3331. As the duplex printing function, all of the items “SIMPLEX”, “DUPLEX (LONG-SIDE BINDING)”, and “DUPLEX (SHORT-SIDE BINDING)” are displayed, but for the item “SIMPLEX”, a mark indicating that the setting is disabled is displayed. Even if the user selects the item “SIMPLEX”, an item other than “SIMPLEX” is selected by the effect of the above-described combined GPD file 181. Consequently, the user cannot select the item “SIMPLEX”. As an alternative configuration, displaying the item “SIMPLEX” as an option may be omitted.

FIG. 16A illustrates states of the respective objects of the driver, the queue, and the port after the execution of step S306. FIG. 16B illustrates states of the respective objects of the driver, the queue, and the port after the execution of step S308.

In FIG. 16A, the customized queue 125 to which the combined GPD file 181, which specifies the customized print function, is applied is associated with the WSD port 124 specifying the virtual WSD application 192 as the output destination. To customize the print function, it is necessary to temporarily set the customized queue 125 to the state illustrated in FIG. 16A where printing can be performed on the virtual WSD application 192, which is an output destination different from the printer 20, i.e., the final output destination.

Then, the TCP/IP port 126 that enables printing on the printer 20 (the actual output destination) is registered, the property of the customized queue 125 is changed via the API, and the customized queue 125 is associated with the TCP/IP port 126. By this processing, as illustrated in FIG. 16B, the output destination of the customized queue 125 is changed to the printer 20.

In the above description, the customization processing of the printer driver 17 and the installation processing of the printer driver 17 according to the first exemplary embodiment have been described.

By the above-described configuration, the following effect can be obtained. That is, a restriction can be put on a printer driver by acquiring information necessary to restrict the printer driver from a virtual WSD application, without storing the printer driver and the information necessary to restrict the printer driver into a printer.

Hereinafter, a second exemplary embodiment will be described.

In the first exemplary embodiment, the customization performed by the customization application 31 on the installation PC 30 has been described. In the first exemplary embodiment, however, customization performed on a body panel UI of the printer 20 (the output destination) is not considered. The customization performed on the body panel UI of the printer 20 is, for example, customization for adding a new paper type. Each paper type includes physical properties such as a grammage and a surface property, and the printer 20 is required to perform the print control corresponding to the physical properties of each paper type.

In some cases, however, the physical properties of a paper type the user actually desires to use do not match any of the paper types originally specified in the printer 20. To deal with such a case, the printer 20 includes an input unit capable of registering information of a new paper type, together with its physical properties.

In the second exemplary embodiment, a method for integrating both the customization setting performed using the customization application 31 and the customization setting performed using the panel UI of the printer 20 with the virtual WSD application 192, and finally reflecting the settings in the printer driver 17 will be described.

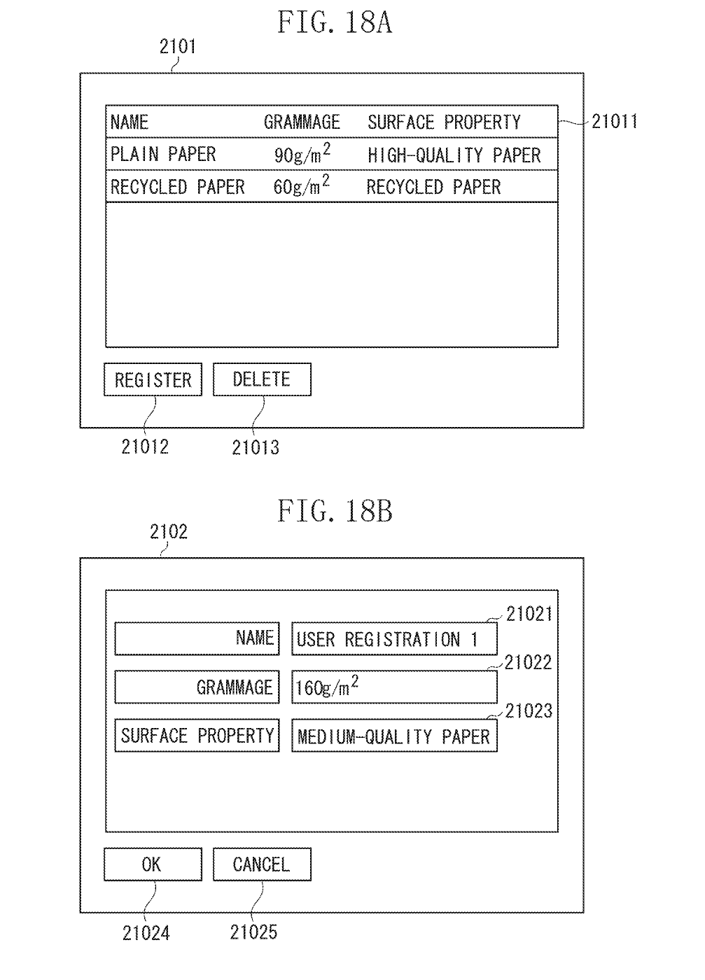

FIG. 18A illustrates a screen 2101 for registering a new paper type in the printer 20, which is to be displayed on the panel UI. In a table 21011 on the screen 2101, a list of paper types currently registered is displayed. In response to a REGISTER button 21012 being pressed, the screen 2101 shifts to a screen 2102 for entering information of a new paper type. When the user presses a DELETE button 21013, a registered paper type can be deleted (only an element the user has additionally registered can be deleted).

FIG. 18B illustrates the screen 2102 for entering the information of a new paper type. On the screen 2102, attributes such as a name, a grammage, and a surface property of a new paper type are to be entered in fields 21021, 21022, and 21023, respectively. When the user presses an OK button 21024, the new paper type is registered, and the information is reflected in the table 21011.

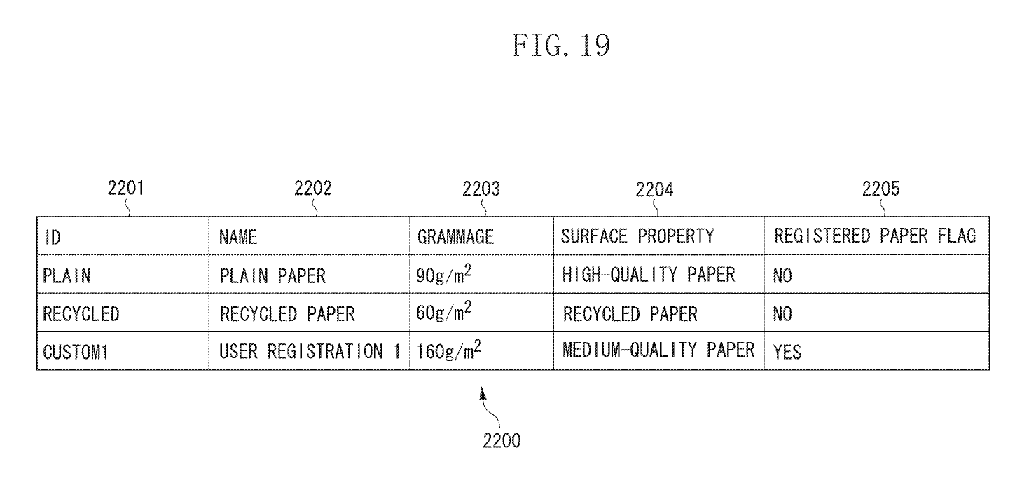

FIG. 19 illustrates an example of a paper type database 2200. The paper type database 2200 is used to manage the information of the paper types available in the printer 20. The paper type database 2200 is stored in the external memory 211 of the printer 20, and managed by the printer controller 26. An input for registering or deleting of a new paper type on the screen 2101 and the screen 2102 is reflected in the paper type database 2200 by the printer controller 26.

As the attributes of the paper type database 2200, an ID 2201, a name 2202, a grammage 2203, a surface property 2204, and a registered sheet flag 2205 are defined. The elements of the paper type database 2200 are roughly classified in two: a paper type originally available in the printer 20, and a paper type additionally registered by the user. For the originally available paper type, the attribute of the registered sheet flag 2205 is set to NO, and for the additionally registered paper type, the attribute of the registered paper flag 2205 is set to YES. For the ID 2201 of the originally available paper type, values such as “PLAIN” and “RECYCLED” are defined in advance. For the ID 2201 of the additionally registered paper type, a value such as “CUSTOM1” is uniquely assigned at the time of the registration.

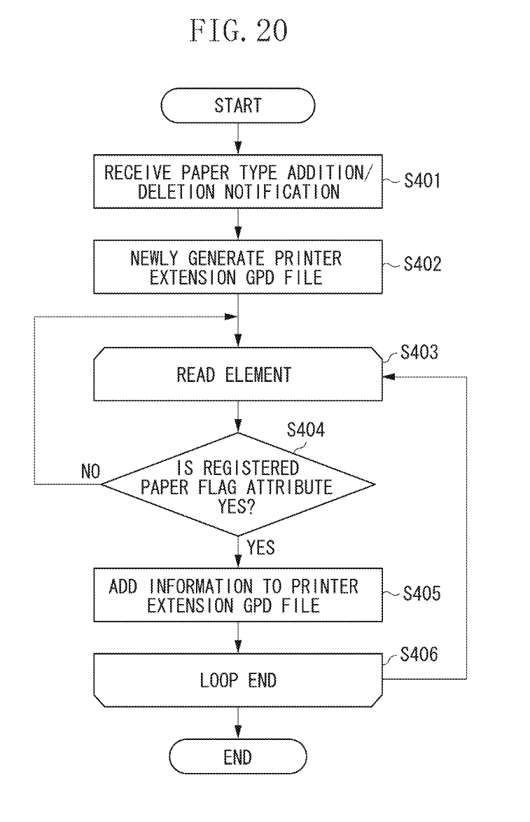

FIG. 20 is a flowchart illustrating a flow of the processing for generating a printer extension GPD file 183 by the function expansion module 27 to be executed on the printer 20.

The printer extension GPD file 183 includes the customization information performed on the body panel UI of the printer 20.

In step S401, the function expansion module 27 receives, from the printer controller 26, a notification of a change in the paper type database 2200, more specifically, a notification indicating the addition or deletion of a new paper type.

In step S402, the function expansion module 27 newly generates the printer extension GPD file 183. The printer extension GPD file 183 is stored in the external memory 211, and newly generated each time the addition or deletion of a paper type occurs. Consequently, the information stored before starting the processing is to be erased.

In steps S403 to S406, the function expansion module 27 accesses the paper type database 2200, reads the elements one by one from the top, and repeats the processing in steps S404 and S405.

In step S404, if the attribute of the registered paper flag 2205 of the read element is set to YES (YES in step S404), the function expansion module 27 proceeds to step S405. If the attribute of the registered paper flag 2205 of the read element is set to NO, the function expansion module 27 returns to step S403 to read the next element.

In step S405, the function expansion module 27 adds the ID attribute and name attribute included in the read element (element of an additionally registered paper type) to the printer extension GPD file 183.

In response to the completion of step S406, the printer extension GPD file 183 is stored in the external memory 211 of the printer 20.

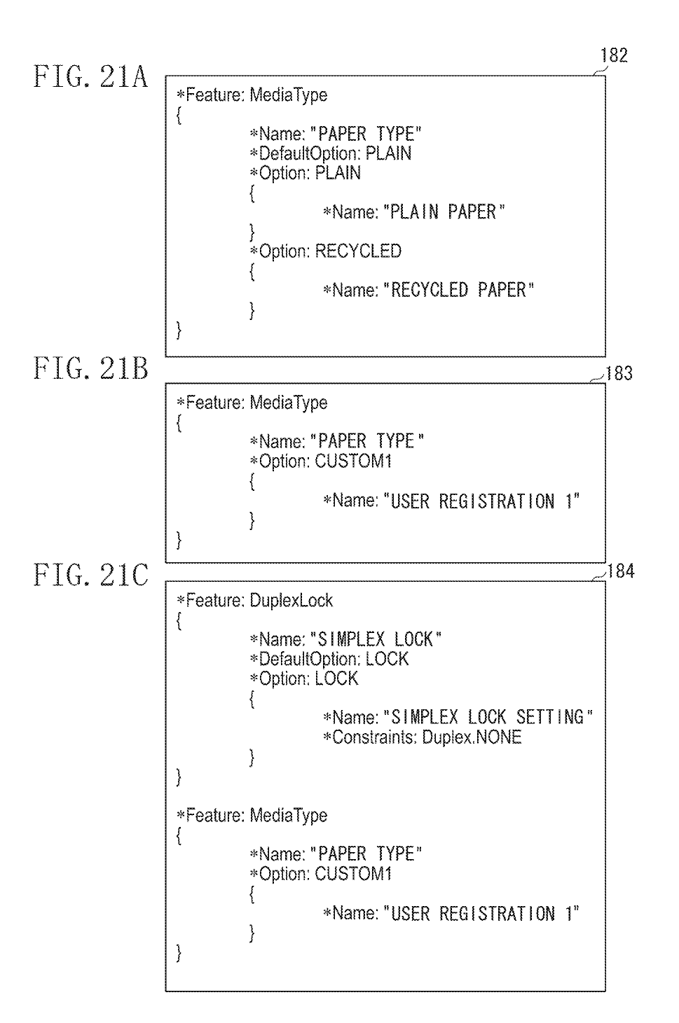

FIG. 21A illustrates an example of the description in the GPD file 182 regarding the paper type originally specified in the printer driver 17.

FIG. 21B illustrates an example of the description in the generated printer extension GPD file 183. The printer extension GPD file 183 is different from the original GPD file 182 and is specified to include only the functional information of the additionally registered paper type.

The installation processing of the printer driver 17 according to the second exemplary embodiment will be described.

In the second exemplary embodiment, both the customization information of the PC extension GPD file 18 and the customization information of the printer extension GPD file 183 are reflected in the printer driver 17.

To implement the processing, the GPD file generated by combining the PC extension GPD file 18 and the printer extension GPD file 183 needs to be read in step S213 of the sequence in FIG. 8 that has been described in the first exemplary embodiment. The processing for combining the PC extension GPD file 18 and the printer extension GPD file 183 is referred to as integrated extension processing.

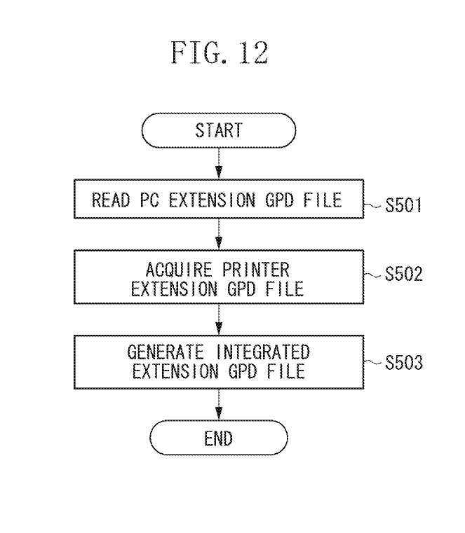

FIG. 12 is a flowchart illustrating a flow of the integration extension processing. The virtual WSD module 1923 in the virtual WSD application 192 performs the integration extension processing.

In step S501, similarly to the first exemplary embodiment, the virtual WSD module 1923 reads the PC extension GPD file 18 included in the installation set 16.

In step S502, to reflect the information of the printer extension GPD file 183 in the printer driver 17, the virtual WSD module 1923 communicates with the printer 20 to acquire the printer extension GPD file 183, which is the print function information of the printer 20. An HTTP GET method is used to acquire the printer extension GPD file 183 from the printer 20.

After the virtual WSD module 1923 acquires the printer extension GPD file 183, in step S503, the virtual WSD module 1923 combines the PC extension GPD file 18 and the acquired printer exertion GPD file 183 to generate an integrated extension GPD file. By this processing, the print function information acquired from the virtual WSD application 192 and the print function information acquired from the printer 20 are combined.

The integrated extension processing has been described above.

By performing the integrated extension processing, the print setting screen of the customized queue 125 is displayed based on the integrated extension GPD file generated in step S503.

FIG. 21C illustrates an example of an integrated extension GPD file 184. The DuplexLock function in the first half part specifies the disabling of a part of the items in the duplex printing included in the PC extension GPD file 18. The MediaType function in the latter half part specifies the addition of a new paper type included in the printer extension GPD file 183.

By combining the integrated extension GPD file 184 with the original GPD file 172, both the customization setting for disabling a part of the items in the duplex printing (performed on the PC 10) and the customization setting for adding a paper type (performed on the printer 20) are reflected in the print function of the printer driver 17.

FIG. 17B illustrates a screen 3332 of the printer driver 17 in a state where both the customization setting for disabling a part of the items in the duplex printing (performed on the PC 10) and the customization setting for adding a paper type (performed on the printer 20) are reflected in the printer driver 17.

As described above, according to the second exemplary embodiment, the results of both the customization performed using the customization application 31 and the customization performed using the body panel UI of the printer 20 can be reflected in the printer driver 17.

The exemplary embodiments can be implemented by supplying a program for implementing at least one of the functions of the above-described exemplary embodiments to a system or apparatus via a network or a storage medium, and causing at least one processor in a computer of the system or apparatus to read and execute the program.

Alternatively, the exemplary embodiments of the present invention can be implemented by a circuit (for example, an application-specific integrated circuit (ASIC)) for implementing at least one of the functions.

According to the exemplary embodiments, a restriction can be put on a printer driver without storing the printer driver and information necessary to restrict the printer driver in an image forming apparatus.

Additional embodiments can also be realized by a computer of a system or apparatus that reads out and executes computer executable instructions recorded on a storage medium (e.g., non-transitory computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2014-118113, filed Jun. 6, 2014, which is hereby incorporated by reference herein in its entirety.

What is claimed is:

1. An information processing apparatus comprising:
a specification unit configured to specify an image forming apparatus;
a launching unit configured to launch an application that responds to a search for image forming apparatuses;
an acquisition unit configured to acquire print function information relating to a print setting screen from the application; and
a display unit configured to display a print setting screen that corresponds to the image forming apparatus specified by the specification unit and is based on the print function information.

2. The information processing apparatus according to claim 1, wherein the acquisition unit performs a search for image forming apparatuses and acquires the print function information from the application as a response to the search.

3. The information processing apparatus according to claim 1, wherein an operating system of the information processing apparatus combines the print function information acquired by the acquisition unit and print function information of a printer driver, and
wherein the print setting screen is displayed based on the combined print function information.

4. The information processing apparatus according to claim 1, further comprising:
a registration unit configured to register a queue that specifies the application as an output destination; and
a change unit configured to change the output destination of the queue from the application to the image forming apparatus specified by the specification unit.

5. The information processing apparatus according to claim 1, wherein the specification unit performs a search for image forming apparatuses, enables a user to select, from image forming apparatuses found as a result of the search, a desired image forming apparatus, and then specifies the image forming apparatus.

6. The information processing apparatus according to claim 1, further comprising another acquisition unit configured to acquire print function information from an image forming apparatus that is an output destination,
wherein the print setting screen is displayed based on the print function information acquired from the application by the acquisition unit and the print function information acquired from the image forming apparatus by the second acquisition unit.

7. A method for controlling an image forming apparatus, the method comprising:
specifying an image forming apparatus;
launching an application that responds to a search for image forming apparatuses;
acquiring print function information relating to a print setting screen from the application; and
displaying a print setting screen that corresponds to the specified image forming apparatus and is based on the print function information.

8. The method according to claim 7, further comprising performing a search for image forming apparatuses,
wherein the print function information is acquired from the application as a response to the search.

9. The method according to claim 7, wherein an operating system of the information processing apparatus combines the acquired print function information and print function information of a printer driver, and
wherein the print setting screen is displayed based on the combined print function information.

10. The method according to claim 7, further comprising:
registering a queue that specifies the application as an output destination; and
changing the output destination of the queue from the application to the specified image forming apparatus.

11. The method according to claim 7, further comprising performing a search for image forming apparatuses, selecting a desired image forming apparatus from image forming apparatuses found as a result of the search, and specifying the image forming apparatus.

12. The method according to claim 7, further comprising acquiring print function information from an image forming apparatus that is an output destination,
wherein the print setting screen is displayed based on the print function information acquired from the application and the print function information acquired from the image forming apparatus.

13. A non-transitory computer-readable storage medium storing computer executable instructions for causing a computer to execute a method for controlling an image forming apparatus, the method comprising:
specifying an image forming apparatus;
launching an application that responds to a search for image forming apparatuses;
acquiring print function information relating to a print setting screen from the application; and
displaying a print setting screen that corresponds to the specified image forming apparatus and is based on the print function information.
